(19) United States
(12) Patent Application Publication
(10) Pub. No.: US 2009/0315699 A1
(43) Pub. Date: Dec. 24, 2009

(54) HOME SECURITY SYSTEM USING AN AD-HOC WIRELESS MESH AND METHOD THEREOF

(75) Inventors: Kathirisetti Satish, Hyderabad (IN); Chachan Navnit, Hyderabad (IN); Dasari Uday Kumar Reddy, Hyderabad (IN)

Correspondence Address: ABELMAN, FRAYNE & SCHWAB, 666 THIRD AVENUE, 10TH FLOOR, NEW YORK, NY, 10017, US

(73) Assignee: TANLA SOLUTIONS LIMITED, Hyderabad (IN)

(21) Appl. No.: 12/307,273

(22) PCT Filed: Jul. 3, 2007
(86) PCT No.: PCT/IN2007/000271

§ 371 Date: Jan. 1, 2009

(30) Foreign Application Priority Data
Jul. 3, 2006 (IN) 1144/CHE/2006

(51) Int. Cl. G08B 1/08

(52) U.S. Cl. 340/533; 340/531; 340/539.14

(57) ABSTRACT

An automation and security system includes a plurality of communication nodes configuring one or more ad-hoc mesh networks. The communication nodes are operatively coupled with at least one of an automation device and/or a security device. The automation and/or the security device senses the occurrence of a situation and communicates a situation data of the situation in real-time to the communication nodes. The situation data is then dynamically routed over the ad-hoc mesh network to a central monitoring station which then automatically processes the situation data to provide a real-time notification to the end user of the system.

### FIELD OF THE INVENTION

The present invention relates to automated solutions for remote notification, and, more specifically, relates to an automation and security system which provides real-time notification of a situation to an end user, using one or more ad-hoc mesh networks

### BACKGROUND OF THE INVENTION

Remote monitoring systems provide an end user of the monitoring system with access to desired data from remote locations. In addition to being cost-effective and convenient, such monitoring systems provide an efficient and reliable solution for delivering data to the end user of the monitoring system. For instance, the usage of utility commodities, such as electricity, water, gas, steam and the like, is conveniently determined by utility service providers using automation devices such as light meter readers, gas meter readers and the like. The monitoring systems in this case employ technologies and methods for remotely reading a plurality of utility meters that allow usage data to flow from a utility meter to a host computer having a billing system, without human intervention. Since no manual reading of the utility meters is involved, additional costs otherwise incurred due to human error are avoided.

Another area of application for such remote monitoring systems is home security. Security is the primary concern for most homeowners. The home needs to be protected from threats such as theft of valuable assets, intrusion, damage to property or any such adverse condition. Typical monitoring systems for securing a household monitor doors and windows of a residence when activated. If a door or a window is opened or broken, the monitoring system sounds an alarm in an attempt to alert the police or to alert the neighbors to call the police or otherwise apprehend the intruder. However, such monitoring systems do not provide any warning to the homeowner of a possible intruder presence. Moreover, the monitoring systems do not monitor the valuable assets which are placed near the monitored area.

In order to monitor the valuable assets, the home is typically divided into different zones. For example, the home may be divided into a garage, a basement, and main living quarters. Security devices (generally in the form of sensors) may be installed in each of these zones. In addition, a central monitoring station, generally referred to as a main control unit, is provided to constantly monitor all the security devices in the system. On detecting an alert situation, the security devices communicate with the central monitoring station which then performs actions such as, but not limited to, sounding sirens in an attempt to alert the police or alert the neighbors.

The automation devices or the above mentioned security devices are coupled to the central monitoring station either through a wired connection or using a wireless communication channel. Wiring these devices to the central monitoring station require extensive modifications to the premises. Laying the cable is also an expensive proposition, and the length of the cable moreover serves to limit the way the security devices are connected to the central monitoring station. Further, in such a set-up, any addition/removal of such devices is a cumbersome process and might require the need to upgrade the central monitoring station to handle a new configuration.

Automation devices and/or the security devices may be connected wirelessly to the central monitoring station to solve the above-mentioned problem. The wireless connection neither involves laying expensive cable nor requires any modification to the premises. But the existing wireless systems are set-up in point-to-point communication with the central monitoring station, thereby limiting the way in which these devices are deployed in the network. Moreover, typically these devices are deployed in a fixed network which makes it very difficult to integrate them with other networks. Further, any addition/removal of these devices requires re-programming of the central monitoring station.

It is also desired that monitored data from the automation device and/or the security device is conveyed to the central monitoring station in real-time. In order to convey the monitored data in real-time, these devices need to be activated 99% of the time, which results in substantial power consumption. Typical automation devices and/or security devices conserve power by monitoring the premises at pre-defined intervals. The devices in this case go through a periodic wake-up/sleep cycle. The monitored data is detected only when the devices are in wake-up mode, resulting in a delay in the transmission to the central monitoring station.

These monitoring systems may also suffer from a failure of the network. For instance, in case of an intrusion, the intruder may dismantle the power-line channel to the main control unit. Similarly, in case of a wireless network, the wireless transmission of a warning signal may be prevented by noise in the wireless channel or by the introduction of a frequency jamming device.

Based on the problems mentioned above with regard to remote monitoring systems, there exists a need for a monitoring system providing real-time response to the end user of the system. The monitoring system needs to be self-configuring, requiring little or no manual intervention, and needs to preclude any need of manual intervention with respect to re-programming of the network. Further, provisions need to be made in the monitoring system for fail-safe mechanism. More specifically, the monitoring system needs to have back-up means for providing monitored data to the end user, in an event of a network failure. Moreover, the monitoring system needs to be flexible to accommodate modifications made to the system.

Also, what is needed is a remote monitoring system that provides real-time response to the end user in a power efficient manner.

### SUMMARY OF THE INVENTION

An object of the invention is to provide a fully automated remote notification system.

Another object of the invention is to provide real-time notification of an occurrence of a situation to an end user of the remote notification system.

Yet another object of the invention is to provide a fail-safe mechanism with back-up communication means to relay a situation data to the end user of the remote notification system.

Still another object of the invention is to provide a remote notification system that has low power consumption.

Yet another object of the invention is to provide a remote notification system which is flexible to accommodate any modification made to the system.

In view of the foregoing disadvantages inherent in the prior art, the general purpose of the present invention is to provide an automation and security system for providing real time notification to an end user using one or more ad hoc mesh networks, to include all the advantages of the prior art, and to overcome the drawbacks inherent therein. Sites to be monitored are installed with one or more automation devices and/or security devices. Each of the one or more automation devices and/or security devices is operatively coupled with communication nodes. The communication nodes configure one or more ad-hoc mesh networks. The one or more automation devices and/or security devices sense an occurrence of a situation at the site and provide situation data in real-time to the one or more ad-hoc mesh networks. The situation data is dynamically routed over the one or more ad-hoc mesh networks to a central monitoring station. The central monitoring station automatically processes the situation data and provides a real-time notification of the occurrence of the situation to the end user of the system without the need of manual intervention. The automation and security system thus provides a fully automated remote notification system for providing real-time notification to the end-user of the system.

Further, suitable back-up means are provided to provide real-time notification to the end user. The automation and security system provides routing means for routing the situation data over one or more physical medium and using one or more communication protocols. The automation and security system thus provides a fail-safe mechanism for providing real-time notification to the end user.

Moreover, the one or more ad-hoc mesh networks are capable of adapting themselves to failure of one or more communication nodes. The one or more ad-hoc mesh networks are also capable of determining newly added communication nodes and integrating them in the one or more ad-hoc mesh networks. This provides the necessary flexibility to the automation and security system as communication nodes may be added or removed without any need for substantial modification to the one or more ad-hoc mesh networks.

In one aspect of the present invention, the communication nodes configuring the one or more ad-hoc mesh networks are coupled with each other using low power/low range radio frequency (RF) transceivers. To provide real-time notification to the end user of the system, the communication nodes need to be operative all the time. The low power/low range RF transceivers consume very little power and thereby help in reducing the power consumed by the communication nodes.

These together with other aspects of the present invention, along with the various features of novelty that characterize the invention, are pointed out with particularity in the claims annexed hereto and form a part of this disclosure. For a better understanding of the invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a block diagram of an automation and security system, in accordance with various embodiments of the present invention;

FIG. 2 is a block diagram of a communication node operably coupled with an automation device and/or a security device, in accordance with an embodiment of the present invention;

FIG. 3 is a block diagram of a central monitoring station, in accordance with an embodiment of the present invention;

FIG. 4 is a block diagram of an exemplary environment, in accordance with an embodiment of the present invention;

FIG. 5 illustrates a data packet message structure, in accordance with an embodiment of the present invention; and

FIG. 6 is a flow diagram illustrating a method for providing automatic real-time notification to an end user of an occurrence of a situation at a site, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a particular automation and security system, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention provides a system and a method for providing automatic real-time notification to an end user of an occurrence of a situation at a site, over an ad-hoc mesh network. Communication nodes configuring the ad-hoc mesh network are provided. The communication nodes are operatively coupled with one or more automation device and/or a security device. The one or more automation device and/or the security device sense the occurrence of the situation and provide a situation data of the situation in real-time to the ad-hoc mesh network. The situation data is dynamically routed over the ad-hoc mesh network to a central monitoring station. The central monitoring station automatically processes the situation data and provides real-time notification to the end user of the system. The system is further capable of responding to an instruction from the end user, sent in response to the real-time notification provided by the central monitoring station.

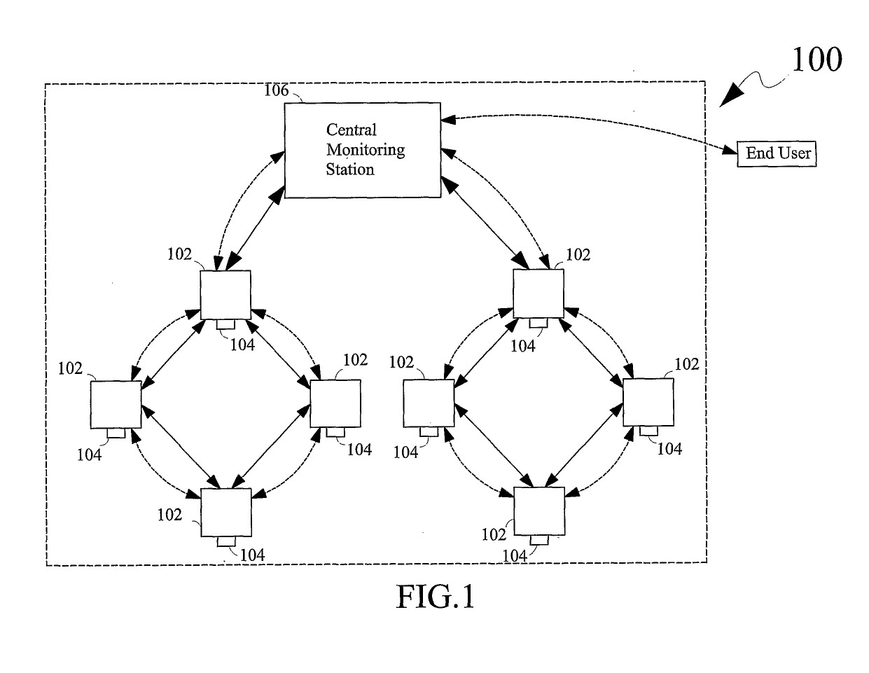

FIG. 1 is a block diagram of an automation and security system 100 (hereinafter referred to as system 100), in accordance with various embodiments of the present invention. The system 100 includes a plurality of communication nodes such as communication node 102, configuring at least one ad-hoc mesh network, and a central monitoring station 106 in operative communication with the at least one ad-hoc mesh network. Further, each communication node 102 is in operative communication with an automation device and/or a security device 104 (hereinafter collectively referred to as device 104).

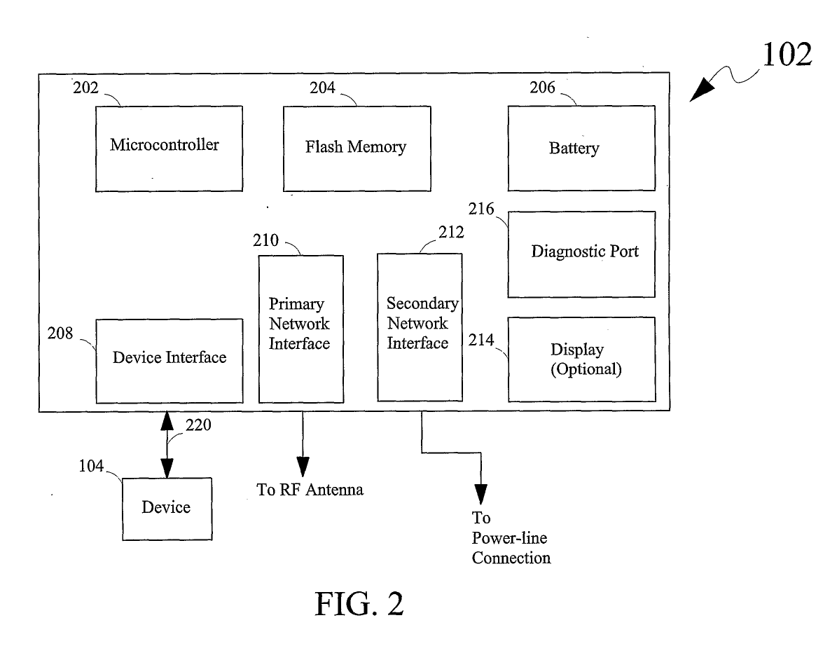

Referring to FIG. 2, is a block diagram of a communication node 102 (of the plurality of communication nodes shown in FIG. 1) operably coupled with an automation device and/or a security device such as device 104, in accordance with an embodiment of the present invention. The communication node 102 comprises a microcontroller 202, a flash memory 204, and a battery 206. The microcontroller 202 is capable of executing programmable instructions for performing the operations of the communication node 102. The microcontroller 202 may take the form of an integrated chip that has all the components of a controller, i.e., a central processing unit (CPU), a random access memory (RAM), a read only memory (ROM), input/output interfaces and timer circuits. Alternatively, the microcontroller 202 may be implemented as a software program. The flash memory 204 is capable of storing the necessary programmable instructions and the data structures located on the communication node 102. Flash memory 204 may take the form of a memory card, memory stick, compact flash or any such form of non-volatile memory.

The battery 206 supplies power to the communication node 102. The battery 206 may take the form of a non-rechargeable battery or a rechargeable battery. Examples of the non-rechargeable battery may include alkaline battery, zinc-chloride battery, and the like. Examples of the rechargeable battery may include lead-acid based battery, absorbed glass mat (AGM) based battery, Nickel Cadmium battery, Nickel Metal Hydride battery, and the like. Further, suitable electrical circuits and electrical connections may be provided to enable functions, such as recharging of the battery 206 by using, for example, solar energy, a DC power input, and the like.

The communication node 102 further comprises a device interface 208 coupling the communication node 102 to the device 104, i.e., the device interface 208 serves as an interface for transfer of situation data from the device 104 to the communication node 102. The device interface 208 constantly monitors the device 104 for receiving the situation data. On occurrence of a situation, the device 104 communicates with the communication node 102 in real time via device interface 208. Further, the device interface 208 also serves as an interface for transferring control data from the communication node 102 to the device 104. The device interface 208 may include a wired connection or a wireless link to couple the communication node 102 to the device 104. Examples of wired connection may include Local Area Network (LAN), Ethernet, power-line connection and the like. Examples of the wireless link may include optical, infra-red, low power radio frequency (RF) radio and the like.

The communication node 102 communicates with other communication nodes 102 using a network interface. As shown in FIG. 2, the communication node 102 further comprises two network interfaces, more specifically, a primary network interface 210 and a secondary network interface 212. The primary network interface 210 includes a transceiver capable of receiving, repeating, and transmitting the situation data and/or a control data. Using the primary network interface 210, the communication node 102 may function as a receiver, a repeater, and a transmitter to the other communication nodes 102, thereby creating a primary ad-hoc mesh network of the plurality of communication nodes 102. Similarly, secondary network interface 212 may include a transceiver capable of receiving, repeating, and transmitting situation data and/or control data, and accordingly a secondary ad-hoc mesh network of the plurality of communication nodes 102 is created. The ad-hoc mesh network configured by the plurality of communication nodes may be one of the primary ad-hoc mesh network or the secondary ad-hoc mesh network.

The primary ad-hoc mesh network and the secondary ad-hoc mesh networks use different physical mediums such as a wired medium or a wireless medium, with the associated communication protocols for routing the situation data. In accordance with a preferred embodiment of the invention, the plurality of communication nodes configures a dual mesh network comprising a primary ad-hoc mesh network and a secondary ad-hoc mesh network. The dual mesh network is depicted in FIG. 1, the primary ad-hoc mesh network formed by the bi-directional communication dotted lines between the communication nodes 102 and the secondary ad-hoc mesh network formed by the bi-directional communication arrow lines between the communication nodes 102. Further, the primary ad-hoc mesh network in the dual mesh network may be chosen to be a wireless ad-hoc mesh network and the secondary ad-hoc mesh network may be a wired ad-hoc mesh network. In accordance with an alternative embodiment of the present invention, the primary ad-hoc mesh network in the dual mesh network may be chosen to be a wired ad-hoc mesh network and the secondary ad-hoc mesh network may be a wireless ad-hoc mesh network. The wireless ad-hoc mesh network may include a cellular network such as a GSM/GPRS/CDMA/3G network, a Wireless Local Area Network (WLAN), combinations thereof and the like. Examples of communication protocols for wireless ad-hoc mesh network may include Ethernet with Carrier Sense Multiple Access/Collision Avoidance (CSMA/CD) and the like. The wired ad-hoc mesh network may include a LAN, an Ethernet, a world wide web, a power-line network, any combinations thereof and the like. Examples of communication protocols for wired-ad-hoc mesh networks may include Transmission Control Packet/Internet Protocol (TCP/IP) and the like.

In the dual mesh network, the primary ad-hoc mesh network serves as a preferred channel for dynamically routing the situation data and/or the control data in system 100. The secondary ad-hoc mesh network serves as the alternate path for routing the situation data and/or the control data. In case of failure or disruption of the primary ad-hoc mesh network, the system 100 resorts to a failure mode of operation by dynamically routing the situation data and/or the control data over the secondary ad-hoc mesh network. The failure or disruption of the primary ad-hoc mesh network may result out of a failure of one or more communication nodes such as the communication node 102 or an intruder tampering with communication link between the one or more communication nodes and the like.

Thus the dual mesh network provides a desirable back-up mechanism for system 100. The failure mode of operation is especially desirable in an emergency situation such as intrusion as the intruder may attempt to disrupt any means of generation of a warning signal. For instance, the intruder may use a frequency jamming device to disrupt the wireless ad-hoc mesh network. In such a case, the situation data and/or the control data may be routed over the wired ad-hoc mesh network.

In accordance with an embodiment of the present invention, the system 100 constantly monitors the health of the primary ad-hoc mesh network and the secondary ad-hoc mesh network. In case of a failure of both the primary ad-hoc mesh network and the secondary ad-hoc mesh network, the system 100 may perform functions such as notifying appropriate security personnel, adding new communication nodes that bypass the failed the communication nodes 102 and the like.

In accordance with an embodiment of the present invention, the communication node 102 may choose to dynamically route the data over the primary ad-hoc mesh network and the secondary ad-hoc mesh network.

The ad-hoc mesh network has self-healing characteristics, i.e., the ad-hoc mesh network is capable of adapting itself to failure of one or more of the communication nodes 102. For example, during transmission of a situation data, if one or more communication nodes 102 fail, then the ad-hoc mesh network removes these failed communication nodes and defines an alternate path for dynamically routing the situation data to the central monitoring station 106. Similarly, failed communication nodes may be integrated into the ad-hoc mesh network once these nodes are treated for the cause of the failure.

Further, the ad-hoc mesh network has self creating and self-determining characteristics i.e., the ad-hoc mesh network is capable of determining newly-added communication nodes, integrating the newly-added communication nodes (such as the communication node 102) into the ad-hoc mesh network, and updating existing paths for dynamically routing the situation data to the central monitoring station 106. Further, the configuration of the ad-hoc mesh network may be divided into a plurality of radially expanding network levels (i.e., a first network level, a second network level, a third network level, and so forth), such that the communication nodes, (such as communication node 102) at the first network level may be able to communicate with communication nodes at the second network level. Similarly, the communication nodes at the second network level may be able to communicate with the communication nodes at the third network level. In accordance with an embodiment of the present invention, the ad-hoc mesh network defines a route based on a shortest reliable path algorithm, for dynamically routing the situation data or the control data at given point of time.

Optionally, the communication node 102 includes display 214. Display 214 may depict information such as date, time, ON/OFF status of the communication node 102, and the like. The communication node 102 also includes a diagnostic port 216. The diagnostic port 216 monitors the health of the communication node 102 and is capable of reporting a failure of the communication node 102 to the central monitoring station 106 over the ad-hoc mesh network.

It will be evident to a person skilled in the art that communication node 102 may include the requisite electrical circuits and connections to connect the micro-controller 202, the flash memory 204, the battery 206, the device interface 208, the primary network interface 210, the secondary network interface 212, the display 214 and the diagnostic port 216. Further, primary network interface 210 and secondary network interface 212 may include interfaces with requisite connections to transmit/receive the situation data and/or the control data.

Further, the components of the communication node 102, i.e., the micro-controller 202, the flash memory 204, the battery 206, the device interface 208, the primary network interface 210, the secondary network interface 212, the display 214 and the diagnostic port 216, may be implemented as a hardware module, software module, firmware or any combination thereof.

Examples of the device 104 may include an automation device such as automated meter reader, a phone controller, a media controller, utility meter, utility cut-off control, air-conditioning control, motor control, lighting control and the like or a security device such as sensors, for example, a motion sensor, a vibration sensor, a gas sensor, a smoke sensor, an impact sensor, a pollution sensor, a temperature sensor, a humidity sensor, a rainfall sensor, an imaging device, and the like. One or more of the automation device and or the security device such as device 104 may be installed at various locations at a site. The site may include a house, a building structure, a campus, an office premise, and similar such locations. The site may be divided into different zones and at least one device 104 may be installed in each zone to sense the occurrence of the situation.

The device 104 senses the occurrence of the situation and communicates the situation data to the communication node 102 coupled with the device 104. Examples of situations may include, but are not limited to a completion of a periodic interval for reading utility meters; activated or ON condition of the utility devices such as air-conditioner, fan and the like in the absence of residents of a premises; gas leak; presence of smoke; water leakage; broken door or window; theft of valuable asset; damage to property; detection of tampering with the device 104 and presence of intruder on the premises. Examples of situation data include: utility meter readings; situation data such as activation status of utility devices; image data from cameras; alert data such as a siren or alarm bell indicating an intrusion in the premise, theft or tampering of the device 104.

The situation data may be provided by device 104 in real-time to the ad-hoc mesh network which dynamically routes the situation data to the central monitoring station 106. The central monitoring station 106 processes the situation data for further action. For example, the central monitoring station 106 may send notification to the end user of the system 100 of the occurrence of the situation. The notification may be sent in the form of a siren, a flashing light, alert pop-ups on the end user's personal computer, a Short Message Service (SMS), a Multimedia Message Service (MMS), a text message or a video call on the end user's mobile phone, and the like. End user of the system 100 may be a subscriber to the system 100, home-owner, security personnel or any person suggested by the end user to be notified on occurrence of the situation. The notification may be sent to the end user on a variety of communication methods including a wireless network, power-line network, fixed wireless network, wired network, cellular networks like GSM/GPRS/3G/CDMA, and the like.

In accordance with an embodiment of the present invention, the central monitoring station 106 may send the control data to the device 104 over the ad-hoc mesh network. Examples of control data include a command to switch off activated utility devices, sounding an alarm for notifying neighbors and/or security personnel in given premise, status request from a specific device such as device 104, reset of the device 104 or control, switch the ad-hoc mesh network from the primary ad-hoc mesh network to the secondary ad-hoc mesh network, execute control action and the like. The control data may be sent by the central monitoring station 106 with or without the suggestion of the end user.

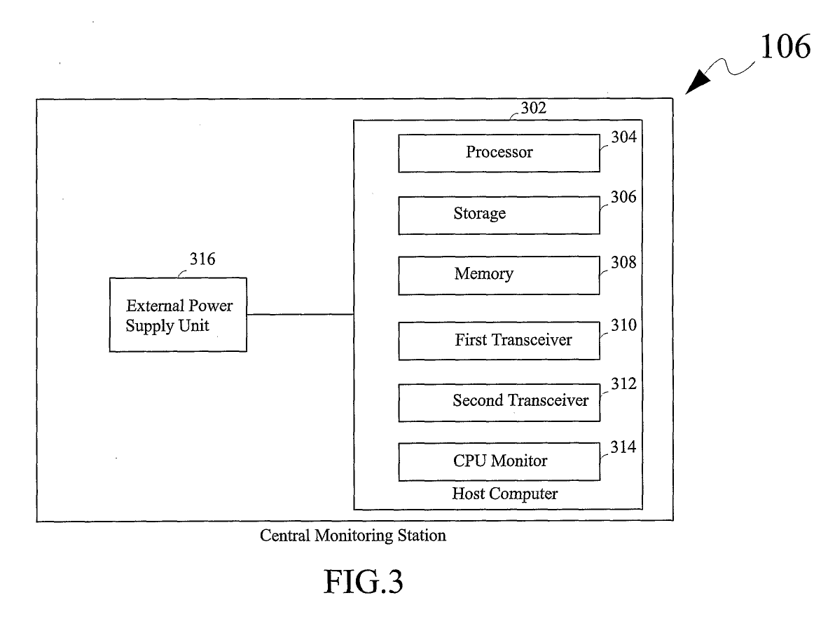

The ad-hoc mesh network configured by the communication nodes 102 therefore support bi-directional communication between central monitoring station 106 and the communication nodes 102. The central monitoring station 106 is explained in conjunction with FIG. 3.

FIG. 3 is a block diagram of the central monitoring station 106, in accordance with an embodiment of the present invention. The central monitoring station 106 includes a host computer 302 capable of processing a situation data and providing real-time notification to an end user of the system 100. The host computer may take the form of a server computer comprising a processor 304, a memory 306, a storage 308, a first transceiver 310, and a second transceiver 312. The processor 304 is capable of executing programmable instructions for performing operations of the central monitoring station 106. In accordance with an embodiment of the present invention, the processor 304 is a hardware module such as a microcontroller or such other integrated chip for executing operations of the central monitoring station 106. In accordance with another embodiment of the present invention, the processor 304 may be implemented as software module for executing operations of the central monitoring station. Preferably, the memory 306 is a random access memory or other type of dynamic storage device, sufficient to hold the necessary programming and data structures located on the central monitoring station 106.

The storage 308 provides the central monitoring station 106 with a means for storing information such as information required for dynamic routing of the situation data and/or the control data. The storage 308 may include a database to store information such as end user information; pre defined response instructions; the communication node 102 information (such as location details and the like); dynamic routing tables from one communication node to another to dynamically route the situation data and/or the control data; the device 104 information such as the type of the device 104 and the like. Further, the storage 308 may include the requisite software for keeping track of the dynamic routing tables controlling the data flow in the ad-hoc mesh network. Examples of the storage 308 may include a fixed and/or removable storage such as tape drives, floppy discs, removable memory cards, or optical storage.

The first transceiver 310 may be a wireless transceiver such as a radio frequency (RF) modem, GSM modem, or PSTN modem, or a GPRS modem capable of establishing communication between the central monitoring station 106 and a communication node such as the communication node 102 or establishing communication between the end user and the central monitoring station 106. In accordance with an embodiment of the present invention, the central monitoring station 106 receives the situation data over a primary ad-hoc mesh network (such as the primary ad-hoc mesh network explained in conjunction with FIG. 2) using the first transceiver 310.

The central monitoring station 106 automatically processes the situation data to provide real-time notification to the end user of the system 100. The automatic processing of the situation data may include checking the authenticity of origin of the situation data by performing actions such as Cyclic Redundancy Check (CRC); identifying the type of information included in the situation data such as but not limited to a utility meter reading or an alarm signal; identifying the end user by matching the origin of the situation data and the end user information stored in the storage 308; and generating a notification in real-time to be relayed to the end user using the first transceiver 310.

Further, the first transceiver 310 may receive instruction from the end user in response to the notification sent by the central monitoring station 106. The central monitoring station 106 may further automatically process instruction sent by the end user which may include, checking the authenticity of origin of the instruction by performing actions such as Cyclic Redundancy Check (CRC); identifying the type of information included in the instruction such as but not limited to payment of bill using a pre-defined account; generating an alarm signal; identifying the device 104 by matching the origin of the instruction and the end user information stored in the storage 308; and generating the control data in real-time to be relayed to the device 104 using the first transceiver 310 over the primary ad-hoc mesh network. The first transceiver 310 in this case may use a cellular interface such as a GSM/GPRS/3G/CDMA connection to notify the end user by sending a short message service (SMS), multimedia message service (MMS), a text message, a video clip and the like. The second transceiver 312 may include interface to connect to a wired network such as a World Wide Web, a local area network, a power-line network, a wide area network and the like. In accordance with an embodiment of the present invention, the central monitoring station 106 receives the situation data over the secondary ad-hoc mesh network (such as the secondary ad-hoc mesh network explained in conjunction with FIG. 3) using the second transceiver 312.

In accordance with an embodiment of the present invention, the central monitoring station 106 may generate the control data on receiving the situation data, based on a pre-defined situation. The pre-defined situation may include receiving instruction from the end user, a situation response defined by the end-user, typical situation responses such as notifying the security personnel in case of an intrusion, and the like. The central monitoring station 106 dynamically routes the control data over the ad-hoc mesh network to the device 104.

The host computer 302 may further include a CPU monitor 314 for monitoring the health of the processor 304. The central monitoring station 106 may include an external power supply unit 316 to supply power for the operation of the host computer 302.

It will be evident to a person skilled in the art that the central monitoring station 106 may include the requisite electrical circuits and connections to connect the processor 304, the memory 306, the storage 308, the first transceiver 310, and the second transceiver 312, the CPU monitor 314 and the external power supply unit 316.

Further, the components of the central monitoring station 106, i.e., the processor 304, the memory 306, the storage 308, the first transceiver 310, the second transceiver 312, the CPU monitor 314 and the external power supply unit 316, may be implemented as a hardware module, software module, firmware or any combination thereof.

In accordance with an embodiment of the present invention, central monitoring station 106 and its components may be implemented as a software program residing in a high end server computer comprising internet connectivity having a public IP address for GPRS, telephone connectivity for PSTN, and mobile phone for GSM data call.

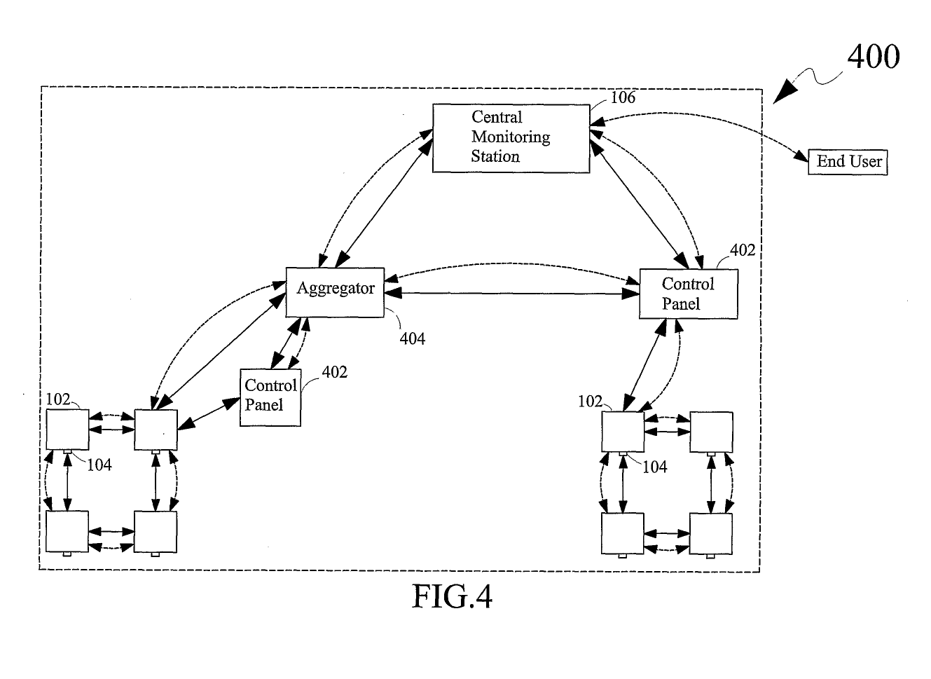

FIG. 4 is a block diagram of an exemplary environment 400 of an automation and security system in accordance with an embodiment of the present invention. Environment 400 includes a plurality of communication nodes such as communication node 102 (explained in conjunction with FIG. 1 and FIG. 2), one or more automation devices and/or security devices such as device 104 (explained in conjunction with FIG. 1), one or more control panels (hereinafter referred to as control panel 402), one or more aggregators (hereinafter referred to as aggregator 404), and a central monitoring station such as central monitoring station 106 (explained in conjunction with FIG. 3). The plurality of communication nodes, one or more control panels such as control panel 402 and one or more aggregators such as aggregator 404 configure an ad-hoc mesh network such as ad-hoc mesh network explained in FIG. 2 for dynamically routing the situation data to central monitoring station 106.

As explained in conjunction with FIG. 1, one or more automation device and/or security device sense an occurrence of a situation and provide situation data in real-time to one or more communication nodes. The communication nodes at a site dynamically route the situation data to the control panel 402. The control panel 402 serves as collection node for gathering the situation data from one or more communication nodes and dynamically routes the situation data to the aggregator 404. The aggregator 404 serves as a collection node and gathers the situation data from one or more control panels such as control panel 402 and dynamically routes the situation data to the central monitoring station 106.

In accordance with an embodiment of the present invention, the plurality of communication nodes, one or more control panels such as control panel 402 and one or more aggregators such as aggregator 404 configure a dual mesh network such as the dual mesh network explained in conjunction with FIG. 2. The dual mesh network comprises a primary ad-hoc mesh network and a secondary ad-hoc mesh network such as those explained in conjunction with FIG. 2.

In various embodiments of the invention, the control panel 402 and the aggregator 404 may be operably coupled with the device 104 for receiving situation data. Further, in various embodiments of the invention, the control panel 402 and the aggregator 404 may function as the communication node 102 performing functions such as collecting, storing and forwarding situation data. The communication nodes in this case may not be coupled with the device 104 and may function as a communication node performing the function of a repeater unit. In another embodiment of the invention, the control panel 402 is optional and the communication nodes may dynamically route the situation data to the aggregator 404.

In accordance with an embodiment of the present invention the ad-hoc mesh network dynamically routes the situation data to the central monitoring station 106 at fixed frequency such as 433 Megahertz (MHz) or at Industrial, Scientific and Medical (ISM) unlicensed radio frequency bands (2.4 Gigahertz). In accordance with another embodiment of the present invention, the ad-hoc mesh network dynamically routes the situation data to the central monitoring station 106 using typical frequency hopping teclmiques.

In accordance with an embodiment of the present invention, the communication node 102 dynamically determines the next communication node to route the situation data. In accordance with an embodiment of the present invention, the central monitoring station 106 updates existing routes for dynamic routing of the situation data and communication node 102 routes the situation data based on dynamic routing tables provided by the central monitoring station 106. The central monitoring station 106 updates the existing routes by keeping a track of the communication nodes such as communication node 102 added or removed from the network.

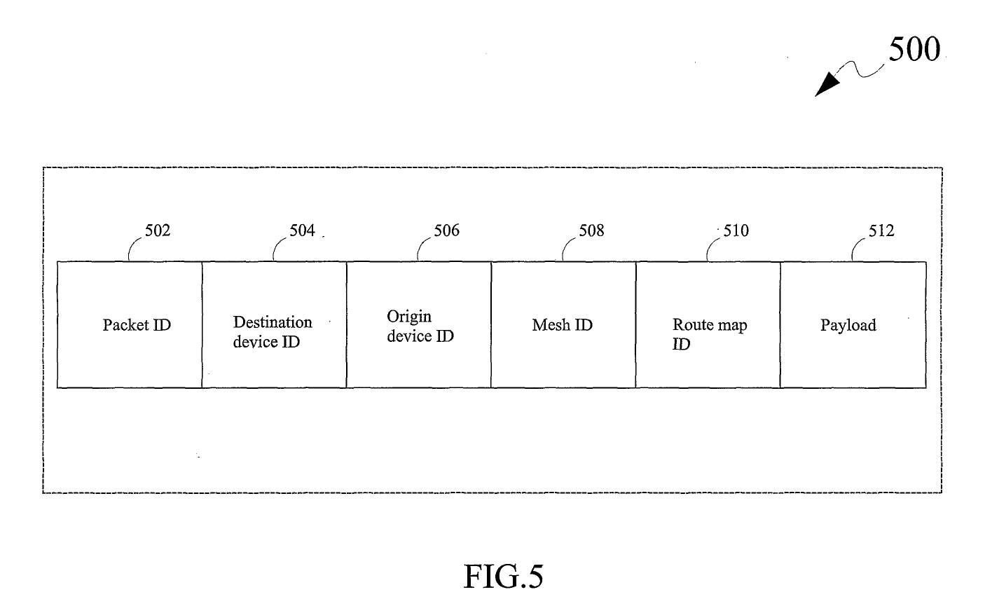

The situation data is dynamically routed over the ad-hoc mesh network in the form of a data packet. In addition to the situation data, the data packet also comprises information for routing the data packet over the ad-hoc mesh network. The transmission of data packets from one communication node such as communication node 102 to another may be governed by methodologies that include, but are not limited to, guaranteed delivery, frequency hopping and the like. The data packet along with its components will be explained in conjunction with FIG. 5.

FIG. 5 illustrates a data packet message structure 500 in accordance with an embodiment of the present invention. The data packet 500 includes the following fields, a packet ID 502, a destination device ID 504, an origin device ID 506, a mesh ID 508, a route map 510 and a payload 512. The packet ID 502 serves to uniquely identify the data packet to avoid duplicates in the reception and transmission of the situation data. The destination device ID 504 serves to identify the next communication node such as the communication node 102, to which the data packet is routed to. The origin device ID 506 serves to identify the source from where the data packet was received. The central monitoring station such as central monitoring station 106 determines the preferred ad-hoc mesh network for data packet 500 (typically the primary ad-hoc mesh network explained in conjunction with FIG. 1).

The mesh ID 508 serves to uniquely identify the ad-hoc mesh network over which the situation data is to be routed. In accordance with another embodiment of the present invention, the central monitoring station 106 broadcasts information such as addition of new nodes or deletion of nodes and the like over the ad-hoc mesh network. The communication nodes 102 on receiving the broadcast information, update a stored route map to dynamically route data packet 500. The stored route map includes information such as the preferred mesh and the destination device ID 504 for data packet 500.

The route map ID 510 field in data packet 500 includes information of all the communication nodes 102 that data packet 500 has traversed. The information is used to build a dynamic routing table for the ad-hoc mesh network.

The payload 512 includes the actual bytes of the situation data received from the device 104. The data packet is routed over the ad-hoc mesh network to the central monitoring station 106. The central monitoring station 106 automatically processes the situation data included in the data packet 500. In one exemplary embodiment, the central monitoring station 106 may first ascertain the uniqueness of the data packet 500 from the packet ID 502. Once ascertained, the central monitoring station 106 may determine the device 104 from which the data packet has originated using the origin device ID 506, the mesh ID 508 and the route map ID 510. On determining the device 104 for the data packet, the central monitoring station 106 may determine the end user to be notified. The central monitoring station may look-up a database matching device ID and end users stored in storage 308. The central monitoring station may then automatically process the situation data to determine the notification message to be sent to the end user. The central monitoring station may send a notification to the end-user in real-time using a first transceiver such as first transceiver 310.

In accordance with an embodiment of the invention, the data packet 500 may further include information such as a date stamp or a time stamp, providing accurate record of the exact day and time of the occurrence of the situation.

In accordance with an embodiment of the invention, the number of bytes in the data packet 500 may vary and as such equal the number of bytes corresponding to the information contained in the data packet 500. In an alternative embodiment, the number of bytes in the data packet 500 may be a fixed number.

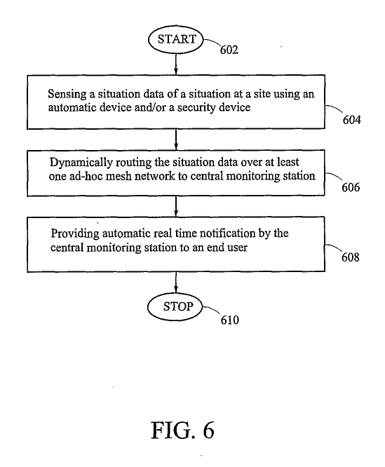

FIG. 6 is a flow diagram illustrating a method for providing automatic real-time notification to an end user of an occurrence of a situation at a site, in accordance with an embodiment of the present invention. The method initiates at step 602 on the occurrence of the situation at the site. At step 604, situation data of the situation at the site is sensed by an automation device and/or security device such as device 104. The sensed situation data is provided in real-time to a communication node such as communication node 102 which together with other communication nodes configure one or more ad-hoc mesh networks. At step 606, the situation data is dynamically routed to the central monitoring station such as central monitoring station 106 over the one or more ad-hoc mesh network. At step 608, the central monitoring station automatically notifies the end user in real-time, of the occurrence of the situation at the site. At step 608, the method terminates when the end-user receives the notification for the occurrence of the situation at the site.

The end user on receiving the notification of the occurrence of the situation at the site may send instruction to the central monitoring station. The central monitoring station may then generate control data based on the instruction received from the end user. Alternatively, the central monitoring station may generate the control data based on some pre-defined situation. For instance, the pre-defined situation may be detection of an intrusion at a site, sensed abnormal condition of a utility device and the like.

Further, the central monitoring station may generate control data with or without the instruction received from the end user. The central monitoring station may then route the control data over the one or more ad-hoc mesh networks to the automation device and/or the security device. The automation device and/or the security device may then respond on the basis of the control data received from the ad-hoc mesh network. The response may include sounding an alarm bell to notify the security personnel or any such personnel suggested by the end user, controlling utility devices such as lighting devices, air conditioning and the like.

In accordance with an embodiment of the present invention, automation and security system such as system 100 is an automated home security system. For example, the automation and security system may be employed by a end user to safe-guard the valuable assets in his house. Accordingly, one or more automation and security devices such as a motion sensor, a vibration sensor and a door/window impact sensor and the like, may be deployed at appropriate locations in the house. The sensor devices sense the situation such as break-in or an intruder presence and provide the sensed data to an ad-hoc mesh network configured by one or more communication nodes coupled to the sensor devices. The ad-hoc mesh network dynamically routes the sensed data in the form of a data packet such as the data packet as explained in FIG. 5, to a central monitoring station. The central monitoring station then notifies the end user in real-time over a cellular network, World Wide Web or such means by sending a SMS, MMS, text messages or a video clip of the occurrence of the situation. The end user may then send an instruction to the sensor devices via the central monitoring station. The sensor devices may then respond to the instruction, for instance, by sounding an alarm, or notifying the neighbour or the police.

In accordance with an embodiment of the present invention, automation and security system such as system 100 may be used to report the usage of utility meters such as power meters, light meters, air-conditioners and the like. The utility meters may send the usage data to a central monitoring station using ad-hoc mesh network of communication nodes coupled with the utility meters. The central monitoring station may then notify the end user of the system 100, of the usage of utility meters. The system 100 may be further programmed to receive the usage data at periodic intervals. Further, since the system 100 provides real-time notification of the usage data, the system 100 may be used for load profiling functions such as providing data for trend analysis and/or forecast in terms of load balancing, preventive maintenance, possible failure, and the like.

In order to provide real-time notification to the end user, the communication nodes constantly monitor the automation device and/or security device. The situation data is then relayed over the ad-hoc mesh network to the central monitoring station. In accordance with a preferred embodiment of the invention, the communication nodes in the ad-hoc mesh network uses low power/low-range RF transceivers to dynamically route the situation data. The ad-hoc nature of the mesh network enables the choice of wireless transceivers in communication node 102 to be low power/low range RF transceivers as the communication node routes the situation data to the nearest communication node to relay the situation data to the central monitoring station. The low power/low range RF transceiver results in substantial power saving. Thus the automation and security system 100 provides an efficient method for providing real-time notification to the end user in a power-efficient manner.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and to thereby enable others skilled in the art to best utilize the invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. An automation and security system, comprising:
a plurality of communication nodes configuring at least one ad-hoc mesh network, each of the plurality of communication nodes in operative communication with at least one of an automation device and a security device, the plurality of communication nodes being capable of providing a real-time response to a situation data of a situation sensed by the at least one of the automation device and the security device; and
a central monitoring station, the central monitoring station operably communicating with the at least one ad-hoc mesh network;
wherein the at least one ad-hoc mesh network is capable of dynamically routing the situation data to the central monitoring station; and
wherein the central monitoring station is capable of automatically processing the situation data and providing the real-time notification to an end user of an occurrence of the situation.

2. The automation and security system of claim 1, wherein the automation and security system is a site monitoring system.

3. The automation and security system of claim 1, wherein the at least one ad-hoc mesh network is a wireless ad-hoc mesh network.

4. The automation and security system of claim 1, wherein the at least one ad-hoc mesh network is a wired ad-hoc mesh network.

5. The automation and security system of claim 1, wherein the at least one ad-hoc mesh network is a dual mesh network.

6. The automation and security system of claim 5, wherein the dual mesh network comprises a wired ad-hoc mesh network and a wireless ad-hoc mesh network.

7. The automation and security system of claim 1, wherein the at least one ad-hoc mesh network is capable of dynamically routing the situation data by defining an alternate path for routing the situation data to the central monitoring station, in an event of failure of at least one of the plurality of communication nodes.

8. The automation and security system of claim 1, wherein the at least one ad-hoc mesh network is further capable of
determining a newly-added communication node,
integrating the newly added communication node into the at least one ad-hoc mesh network, and
updating existing routes for dynamically routing the situation data to the central monitoring station.

9. The automation and security system of claim 1, wherein the central monitoring station provides the real-time notification of the occurrence of the situation to the end user using at least one of a short message service, a multimedia message service, a video clip, a phone call, a text message and a world wide web.

10. The automation and security system of claim 1, wherein the central monitoring station is further capable of generating a control data and dynamically routing the control data over the at least one ad-hoc mesh network to the at least one of the automation device and the security device.

11. The automation and security system of claim 10, wherein the central monitoring station is further capable of processing an instruction received from the end user and generating the control data based on the instruction received from the end user.

12. The automation and security system of claim 10, wherein the central monitoring station is capable of generating the control data based on an occurrence of at least one predefined situation.

13. The automation and security system of claim 10, wherein the at least one of the automation device and the security device is capable of responding on receiving the control data.

14. The automation and security system of claim 1, wherein the at least one ad-hoc mesh network further comprises a plurality of aggregator nodes operatively coupled with the plurality of communication nodes, the plurality of aggregator nodes serving to gather the situation data from the plurality of communication nodes and relaying the situation data to the central monitoring station.

15. The automation and security system of claim 1, wherein the security device is one of a motion sensor, a gas sensor, a smoke sensor, a vibration sensor, an impact sensor, a pollution sensor, a temperature sensor, a humidity sensor, a rainfall sensor, a water quality sensor and an air quality sensor.

16. The automation and security system of claim 1, wherein the automation device is one of a utility meter, a phone controller, a media controller, a utility cutoff control, an air conditioning control, a motor control and a lighting control.

17. An automated site security system, comprising:
a plurality of communication nodes configuring at least one ad-hoc mesh network, each of the plurality of communication nodes in operative communication with a security device, the plurality of communication nodes being capable of providing a real-time response to an alert data of an alert situation sensed by the at least one security device; and
a central monitoring station, the central monitoring station operably communicating with the at least one ad-hoc mesh network;
wherein the at least one ad-hoc mesh network is capable of dynamically routing the alert data to the central monitoring station; and
wherein the central monitoring station is capable of automatically processing the alert data and providing a real-time notification to an end user of an occurrence of the alert situation.

18. The automated site security system of claim 17, wherein the at least one ad-hoc mesh network is a wireless ad-hoc mesh network.

19. The automated site security system of claim 17, wherein the at least one ad-hoc mesh network is a wired ad-hoc mesh network.

20. The automated site security system of claim 17, wherein the at least one ad-hoc mesh network is a dual mesh network.

21. The automated site security system of claim 20, wherein the dual mesh network comprises a wired ad-hoc mesh network and a wireless ad-hoc mesh network.

22. The automated site security system of claim 17, wherein the at least one ad-hoc mesh network is capable of dynamically routing the alert data by defining an alternate path for routing the alert data to the central monitoring station, in an event of failure of at least one of the plurality of communication nodes.

23. The automated site security system of claim 17, wherein the at least one ad-hoc mesh network is further capable of
determining a newly-added communication node,
integrating the newly added communication node into the at least one ad-hoc mesh network, and
updating existing routes for dynamically routing the alert data to the central monitoring station.

24. The automated site security system of claim 17, wherein the central monitoring station provides an real-time notification of the occurrence of the alert situation to the end user using at least one of a short message service, a multimedia message service, a video clip, a phone call, a text message and a world wide web.

25. The automated site security system of claim 17, wherein the central monitoring station is further capable of generating a control data and dynamically routing the control data over the at least one ad-hoc mesh network to the security device.

26. The automated site security system of claim 25, wherein the central monitoring station is further capable of processing an instruction received from the end user and generating the control data based on the instruction received from the end user.

27. The automated site security system of claim 25, wherein the central monitoring station is capable of generating the control data based on an occurrence of at least one predefined situation.

28. The automated site security system of claim 25, wherein the security device is capable of responding on receiving the control data.

29. The automated site security system of claim 17, wherein the at least one ad-hoc mesh network further comprises a plurality of aggregator nodes operatively coupled with the plurality of communication nodes, the plurality of aggregator nodes serving to gather the alert data from the plurality of communication nodes and relaying the alert data to the central monitoring station.

30. The automated site security system of claim 17, wherein the security device is one of a motion sensor, a gas sensor, a smoke sensor, a vibration sensor, an impact sensor, a pollution sensor, a temperature sensor, a humidity sensor, a rainfall sensor, a water quality sensor and an air quality sensor.

31. An automation and security system, comprising:
a plurality of communication nodes configuring at least one ad-hoc mesh network, wherein at least some of the plurality of communication nodes is in operative communication with at least one of an automation device and a security device, the plurality of communication nodes being capable of providing a real-time response to a situation data of a situation sensed by the at least one of the automation device and the security device; and
a central monitoring station, the central monitoring station operably communicating with the at least one ad-hoc mesh network;
wherein the at least one ad-hoc mesh network is capable of dynamically routing the situation data to the central monitoring station; and
wherein the central monitoring station is capable of automatically processing the situation data and providing a real-time notification to an end user of an occurrence of the situation.

32. The automation and security system of claim 31, wherein the automation and security system is a site monitoring system.

33. The automation and security system of claim 31, wherein the at least one ad-hoc mesh network is a wireless ad-hoc mesh network.

34. The automation and security system of claim 31, wherein the at least one ad-hoc mesh network is a wired ad-hoc mesh network.

35. The automation and security system of claim 31, wherein the at least one ad-hoc mesh network is a dual mesh network.

36. The automation and security system of claim 35, wherein the dual mesh network comprises a wired ad-hoc mesh network and a wireless ad-hoc mesh network.

37. The automation and security system of claim 31, wherein the at least one ad-hoc mesh network is capable of dynamically routing the situation data by defining an alternate path for routing the situation data to the central monitoring station, in an event of failure of at least one of the plurality of communication nodes.

38. The automation and security system of claim 31, wherein the at least one ad-hoc mesh network is further capable of:
determining a newly-added communication node,
integrating the newly added communication node into the at least one ad-hoc mesh network, and
updating existing routes for dynamically routing the situation data to the central monitoring station.

39. The automation and security system of claim 31, wherein the central monitoring station provides the real-time notification of the occurrence of the situation to the end user using at least one of a short message service, a multimedia message service, a video clip, a phone call, a text message and a world wide web.

40. The automation and security system of claim 31, wherein the central monitoring station is further capable of generating a control data and dynamically routing the control data over the at least one ad-hoc mesh network to the at least one of the automation device and the security device.

41. The automation and security system of claim 40, wherein the central monitoring station is further capable of processing an instruction received from the end user and generating the control data based on the instruction received from the end user.

42. The automation and security system of claim 40, wherein the central monitoring station is capable of generating the control data based on an occurrence of at least one predefined situation.

43. The automation and security system of claim 40, wherein the at least one of the automation device and the security device is capable of responding on receiving the control data.

44. The automation and security system of claim 31, wherein the remaining communication nodes of the plurality of communication nodes are capable of
gathering the situation data from the at least some of the plurality of communication nodes in operative communication with the at least one the automation and the security device, and
relaying the situation data to the central monitoring station.

45. The automation and security system of claim 31, wherein the security device is one of a motion sensor, a gas sensor, a smoke sensor, a vibration sensor, an impact sensor, a pollution sensor, a temperature sensor, a humidity sensor, a rainfall sensor, a water quality sensor and an air quality sensor.

46. The automation and security system of claim 31, wherein the automation device is one of a utility meter, a phone controller, a media controller, a utility cutoff control, an air conditioning control, a motor control and a lighting control.

47. A method for providing an automatic real-time notification of a situation to an end user of an automation and security system, the method comprising:
sensing a situation and sending a situation data, wherein the sensing is performed by at least one of an automation device and a security device;
dynamically routing the situation data to a central monitoring station over at least one ad-hoc mesh network configured by a plurality of communication nodes, each of the plurality of communication nodes operably communicating with the at least one of the automation device and the security device for receiving the situation data; and
providing the automatic real-time notification to the end user of an occurrence of the situation, wherein the automatic real-time notification is provided by the central monitoring station on receiving the situation data from the at least one ad-hoc mesh network.

48. The method of claim 47, wherein the at least one ad-hoc mesh network is a wireless ad-hoc mesh network.

49. The method of claim 47, wherein the at least one ad-hoc mesh network is a wired ad-hoc mesh network.

50. The method of claim 47, wherein the at least one ad-hoc mesh network is a dual mesh network.

51. The method of claim 50, wherein the dual mesh network comprises a wired ad-hoc mesh network and a wireless ad-hoc mesh network.

52. The method of claim 47, wherein the at least one ad-hoc mesh network dynamically routes the situation data by defining an alternate path for routing the situation data to the central monitoring station, in an event of failure of at least one of the plurality of communication nodes.

53. The method of claim 47, wherein the at least one ad-hoc mesh network further performs dynamic routing by
determining a newly-added communication node,
integrating the newly added communication node into the at least one ad-hoc mesh network, and
updating existing routes for dynamic routing of the situation data to the central monitoring station.

54. The method of claim 47, wherein the central monitoring station provides the automatic real-time notification of the occurrence of the situation to the end user using at least one of a short message service, a multimedia message service, a video clip, a phone call, a text message and a world wide web.

55. The method of claim 47, wherein the at least one ad-hoc mesh network further comprises a plurality of aggregator nodes operatively coupled with the plurality of communication nodes, the plurality of aggregator nodes serving to gather the situation data from the plurality of communication nodes and relaying the situation data to the central monitoring station.

56. The method of claim 47, further comprising generating a control data by the central monitoring station and dynamically routing the control data over the at least one ad-hoc mesh network to the at least one of the automation device and the security device.

57. The method of claim 56, further comprising receiving an instruction at the central monitoring station from the end user and generating the control data by the central monitoring station based on the instruction received from the end user.

58. The method of claim 56, further comprising generating the control data by the central monitoring station on an occurrence of at least one predefined situation.
